(19) United States
(12) Patent Application Publication
(10) Pub. No.: US 2008/0256325 A1
(43) Pub. Date: Oct. 16, 2008

(54) Memory Device and Device for Reading Out

(76) Inventor: Andrei Josiek, Dresden (DE)

Correspondence Address: SLATER & MATSIL, L.L.P., 17950 PRESTON ROAD, SUITE 1000, DALLAS, TX, 75252, US

(21) Appl. No.: 12/100,120

(22) Filed: Apr. 9, 2008

(30) Foreign Application Priority Data
Apr. 16, 2007 (DE) 10 2007 017 735.8

(51) Int. Cl. G06F 12/10

(52) U.S. Cl. 711/202; 711/E12.058

(57) ABSTRACT

A device includes an input for an N-bit data word. A circuit is adapted to map the N-bit data word to a physical M-bit memory data word by means of a mapping rule. The mapping rule includes a quantity of values of possible physical M-bit memory data words the mean number of first physical bit values of which is smaller than N/2. The circuit also includes output for the physical M-bit memory data word. Memory cells are couplable to the output.

This application claims priority from German Patent Application No. 10 2007 017 735.8, which was filed on Apr. 16, 2007, and is incorporated herein by reference in its entirety.

### TECHNICAL FIELD

The present invention relates to memory devices and, in embodiments, describes concepts for reducing data retention failures in, for example, capacitance-based data memories, in particular in DRAM (dynamic random access memory) memories.

### BACKGROUND

Capacitance-based memory components and modules generally exhibit a non-negligible data retention failure rate that is generally different for stored physical ones and physically stored zeros. Thus, the data retention failure rate indicates a portion of data which at the time of reading out are stored incorrectly in the memory, i.e., for example, physical zeros read out which originally were written to the memory as physical ones. The data retention time corresponds to a type of half-life in which an original bit value changes to the complementary one. The data retention failure rate of physical ones in current, so-called deep-trench DRAM memory modules generally is a value of some hundred dpms (defect parts per million), whereas the data retention failure rate of physical zeros is considerably smaller.

The data retention failure rate is, for example, dependent on the respective memory chip design, the manufacturing technology and conditions of usage of the memory component, like, for example, the supply voltages applied.

In order to reduce data retention failure rates, one possibility is optimizing the design of memory chips, manufacturing technologies and other environmental conditions, like, for example, supply voltages for the memory elements.

### BRIEF DESCRIPTION OF THE DRAWINGS

Embodiments of the present invention will be detailed subsequently referring to the appended drawings, in which:

FIG. 1 is a schematic flowchart of a method for storing a data word according to an embodiment of the present invention;

FIG. 2 is a block diagram of a device for storing a data word according to an embodiment of the present invention;

FIG. 3 is a flowchart for explaining mapping of an N-bit data word to an M-bit memory data word according to an embodiment of the present invention;

FIG. 4 is a block diagram of means for mapping an N-bit data word to a physical M-bit memory data word according to an embodiment of the present invention;

FIG. 5 shows a device for reading out an N-bit data word from a memory according to an embodiment of the present invention;

FIG. 6 is a flowchart for explaining mapping of an M-bit memory data word to an N-bit data word according to an embodiment of the present invention;

FIG. 7 is a block diagram of a device for reading out an N-bit data word according to an embodiment of the present invention; and

FIG. 8 shows a system for reducing data retention failure rates according to an embodiment of the present invention.

### DETAILED DESCRIPTION OF ILLUSTRATIVE EMBODIMENTS

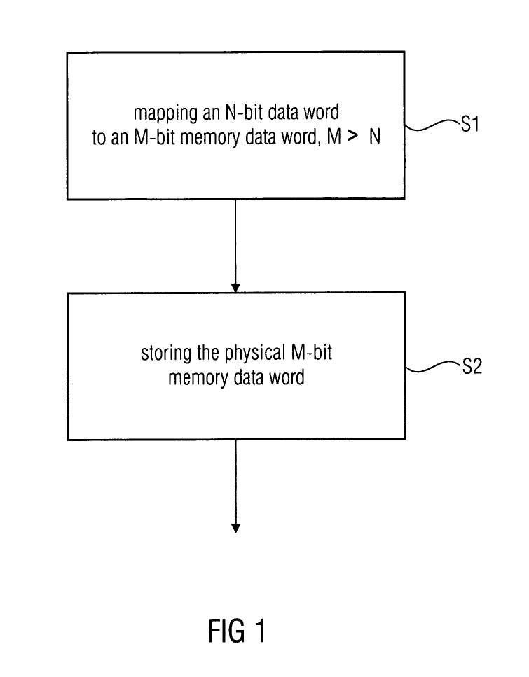

Before embodiments of the present invention will be detailed, referring to FIGS. 1 to 8, what follows below is a general exemplary explanation of DRAM memory cells that will help the understanding of subsequent descriptions of embodiments and the advantages thereof, wherein it is pointed out that DRAM technology has only been chosen exemplarily here.

A DRAM memory cell comprises a capacitor and a transistor. At present, mostly field-effect transistors are used. Information is stored in the capacitor as an electric charge. The transistor, also referred to as a selection transistor, serves as a switch for reading and/or writing information. Several thousand memory cells each are inter-connected in a matrix assembly. Word lines connect all the control electrodes of the selection transistors in one row, and bit lines exemplarily connect all the source regions of the selection transistors of one column. At the edge of the matrix, the bit lines are connected to write/read amplifiers, whereas the word lines are connected to address decoding circuits. A plurality of these memory matrices are interconnected to form one continuous memory region on a memory chip.

Caused by different leakage current mechanisms, a charge stored on the capacitor of a memory cell and corresponding to a physical data bit is lost over time. An increased environmental temperature of the memory cell, among other things, for example, causes the charges stored to comprise higher energies than at lower temperatures and thus to overcome insulation barriers more easily.

The time elapsed until a memory cell is evaluated incorrectly due to the charge dissipated and/or supplied is generally referred to as refresh time or retention. The refresh time is dependent on which physical signal has been stored. If, for example, a physical zero is stored in a memory cell and a cell environment, like, for example, a substrate, connected to a ground potential, normally there will be no reason for the memory cell to lose its charge caused by leakage currents. However, for more precise refresh considerations, it should be kept in mind that the environment of such a memory cell may also include neighboring word lines and/or bit lines and also memory cells comprising physical ones. The charges thereof may, caused by leakage currents, flow to the cell capacitor and thus cause switching from a physical zero to a physical one.

If, on the other hand, a physical one is stored in the memory cell and the cell environment, like, for example, a substrate, is connected to ground potential, charges will be dissipated continuously from the cell capacitor by leakage currents and the physical one will erroneously be evaluated as a physical zero after the refresh time.

For the reasons described before, in capacitance-based memories, of which a DRAM memory cell is an example, the data retention failure rate of stored physical ones can be greater by far than that of stored physical zeros.

In the case described before, instead of optimizing the memory chip design or supply voltages applied, for example, an overall data retention failure rate may be reduced significantly by writing, for each information bit chain to be stored and/or for each data word to be stored, the respective complementary or inverted data word to the memory cells, however, only if the number of physical ones of the data word is higher than the number of physical zeros and the data retention failure rate of stored physical ones is greater than that of stored physical zeros, or if the number of physical zeros of the data word is greater than the number of physical ones and the data retention failure rate of stored physical zeros is greater than that of stored physical ones. Otherwise, the original data word will be written to the memory. Additional control information in the form of a control indicator, like, for example, a control bit, according to embodiments indicates whether the original N-bit data word had more ones than zeros or more zeros than ones or not. If the N-bit data word is long enough, i.e., N is sufficiently great, the memory capacitance additionally necessary for the control bit will be small compared to the memory capacitance for the N-bit data word. If N, for example, equals 1,024, the additional memory necessary for a control bit will be roughly only 0.1% of the memory necessary for the actual information data.

It is common to the subsequent embodiments that, when storing, an N-bit data word is mapped to a physical M-bit memory data word using mapping, M being greater than N. If only one control bit per N-bit data word is used, M=N+1 will apply.

If the N-bit data word is to be read out from the memory, considering the control bits, the same mapping may be performed in the reverse direction to obtain the N-bit data word from the M-bit memory data word. If the control information of the M-bit memory data word indicates that the information bits of the N-bit data word were stored in an inverted manner, N bits of the M-bit memory data word will be inverted again to obtain the original information in the form of the N-bit data word.

Transforming and/or mapping the respective data words may, according to embodiments, take place directly on a memory chip, a central processor or a dedicated hardware interface between the memory and the central processor.

Embodiments of the present invention will be detailed subsequently referring to FIGS. 1 to 8.

FIG. 1 shows a schematic flowchart of a method for storing an N-bit data word according to an embodiment of the present invention.

In a first step S1, the N-bit data word is mapped to a physical M-bit memory data word (M>N) by means of a mapping rule, the mapping rule comprising a quantity of values of possible physical M-bit memory data words the mean number of first physical bit values of which is smaller than N/2. In a second step S2, the physical M-bit memory data word is stored in memory cells.

Put differently, in the first step S1, a number of physical zeros to be stored is increased compared to a number of physical ones to be stored by mapping in the case of a better data retention for physical zeros. If the opposite applies, i.e., if the data retention for physical ones is better than for physical zeros, the number of physical ones to be stored in the second step S2 is increased compared to a number of physical zeros to be stored in the second step S2 by the mapping in the first step S1.

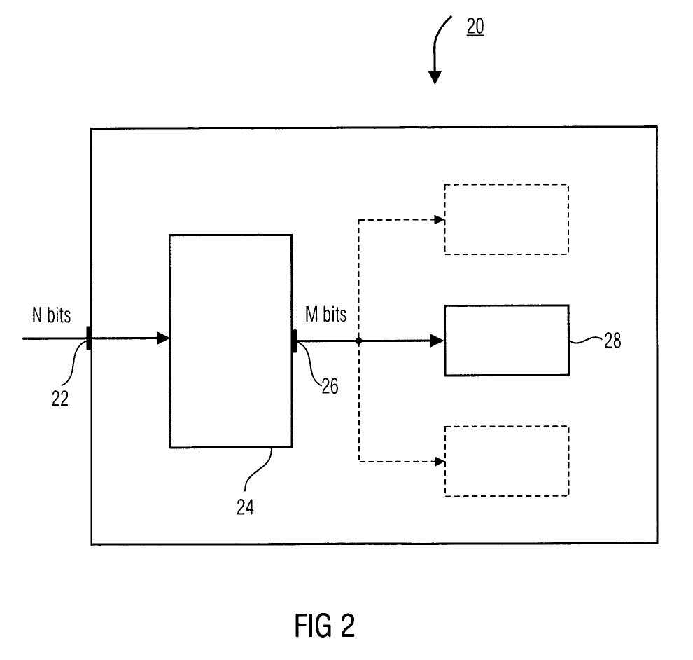

A device 20 for performing the method for storing an N-bit data word described referring to FIG. 1 according to an embodiment of the present invention is shown in FIG. 2.

The device 20 comprises an input 22 for an N-bit data word. Furthermore, the device 20 comprises a circuit 24 coupled to the input 22 which is adapted to map the N-bit data word to a physical M-bit memory data word by means of a mapping rule, the mapping rule comprising a quantity of values of possible physical M-bit memory words the mean number of first physical bit values of which is smaller than N/2. The circuit 24 comprises an output 26 for the physical M-bit memory data word, wherein the output 26 is couplable to memory cells 28.

According to an embodiment, the circuit 24 is adapted to check whether a number of bits having a first logical bit value (0 or 1) in the N-bit data word has a predetermined relation to a predetermined threshold value and, in this case to output an inverting signal and, depending on the inverting signal, the N-bit data word in an inverted or non-inverted manner.

According to an embodiment, the circuit 24 is adapted to check whether a number of bits comprising a logical zero in the N-bit data word is greater than N/2. This predetermined relation to the predetermined threshold value N/2 as a basis for inversion will be of advantage if logical zeros are mapped to physical zeros and the physical zeros comprise a poorer data retention failure rate than physical ones. Furthermore, this implementation is of advantage if logical zeros are mapped to physical ones and these physical ones comprise a poorer data retention failure rate than physical zeros. Correspondingly, the circuit 24 may, of course, also be adapted to check whether a number of bits comprising a logical one in the N-bit data word is smaller than or equal to N/2.

According to another embodiment, the circuit 24 is adapted to check whether a number of bits comprising a logical one in the N-bit data word is greater than N/2. The predetermined relation to the predetermined threshold value of N/2 just described as a basis for inversion will be of advantage if logical ones are mapped to physical zeros and physical zeros comprise a poorer data retention failure rate than physical ones. Furthermore, this implementation is of advantage if logical ones are mapped to physical ones and these physical ones comprise a poorer data retention failure rate than physical zeros, as is the case in many application cases in DRAM memories. Correspondingly, the circuit 24 may, of course, also be adapted to check whether a number of bits comprising a logical zero in the N-bit data word is greater than or equal to N/2.

Thus, the mean number of physical zeros to be stored can be kept smaller than N/2 if the physical zeros comprise a poorer data retention failure rate than physical ones, or the mean number of physical ones to be stored can be kept smaller than N/2 if the physical ones comprise a poorer data retention failure rate than physical zeros.

The greater the bit number N, the lower the mean number of physical bit values to be stored comprising a poorer data retention failure rate, caused by the mapping rule according to embodiments. For N→∞, the mean number of physical bit values to be stored comprising a poorer data retention failure rate will approximate N/4. Thus, the mapping rule according to embodiments comprises a quantity of values of possible physical M-bit memory data words the mean number A of first physical bit values of which is smaller than N/2 and greater than N/4, i.e., N/4<A<N/2. In particular, using the mapping rule according to embodiments, an upper limit of the mean number of physical bit values to be stored comprising a poorer data retention failure rate of (N/4+¾) inclusively can be kept to, wherein exemplarily N≧4.

According to embodiments, the circuit 24 may also be adapted to check whether a number of bits comprising a logical zero or a logical one in the N-bit data word is greater than or equal to N/2. If the number of bits comprising a logical zero or a logical one equals N/2, i.e., if the bits in the N-bit data word are distributed exactly equally, inversion may be performed or not. In this case, inversion will, at most, entail a marginal advantage.

In order to be able to understand whether the N-bit data word has been inverted or not, the circuit 24 according to embodiments is adapted to add additional control bits corresponding to the inversion signal to the N-bit data word mapped to obtain the M-bit memory data word.

According to embodiments, the inversion signal is a one or a zero, depending on whether the N-bit data word has been inverted or not. Thus, the M-bit memory data word according to embodiments includes a control and/or inversion bit in addition to the inverted or non-inverted N-bit data word, i.e., M=N+1.

According to embodiments, the memory cells 28 are capacitance-based memory cells, in particular DRAM memory cells.

The circuit 24 may be referred to as a DBI-DC (data bit inversion-data control) system which is implemented to write the DBI data, i.e., the data inverted under the circumstances described before, directly to a memory array including the memory cells 28. The DBI-DC system 24 may, for example, be integrated in a CPU (central processing unit) or the memory array. Furthermore, the DBI-DC system 24 may be integrated into a memory controller circuit not illustrated explicitly or into a memory buffer. The DBI-DC system 24 and the memory cells 28 may thus be separate circuits between which the DBI data are transferred by corresponding data lines and drivers. The memory cells 28 will in this case store arriving DBI data directly without further processing.

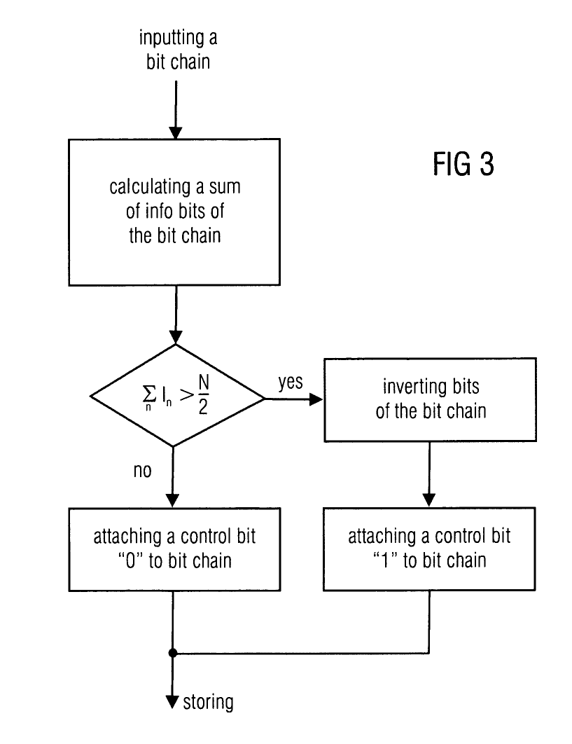

FIG. 3 shows a flowchart for describing mapping of the N-bit data word to the physical M-bit memory data word according to an embodiment of the present invention.

When inputting the N-bit data word into the circuit 24, according to an embodiment the incoming information bits Iₙ (n=1, . . . , N; Iₙ ∈ {0;1}) are summed up. If the sum of the information bits Iₙ exceeds the threshold value N/2, i.e.:

$${\sum }_{i = 1}^{n} {I}_{i} > \frac{N}{2} ,$$

the N bits of the N-bit data word will be inverted and the inversion signal will be added to the inverted N-bit memory data word as a control bit. Thus, the inversion signal may be “1” or “0”, like, for example, “1” for inversion and “0” for no inversion. Subsequently, the resulting M-bit memory data word is stored in the memory cells 28.

If even after completely summing up all the N information bits Iₙ, the threshold value N/2 is not exceeded, i.e.:

$${\sum }_{i = 1}^{n} {I}_{i} \leq \frac{N}{2} ,$$

the N-bit data word will not be inverted and a zero will exemplarily be added as a control bit to indicate that the N-bit data word has not been inverted.

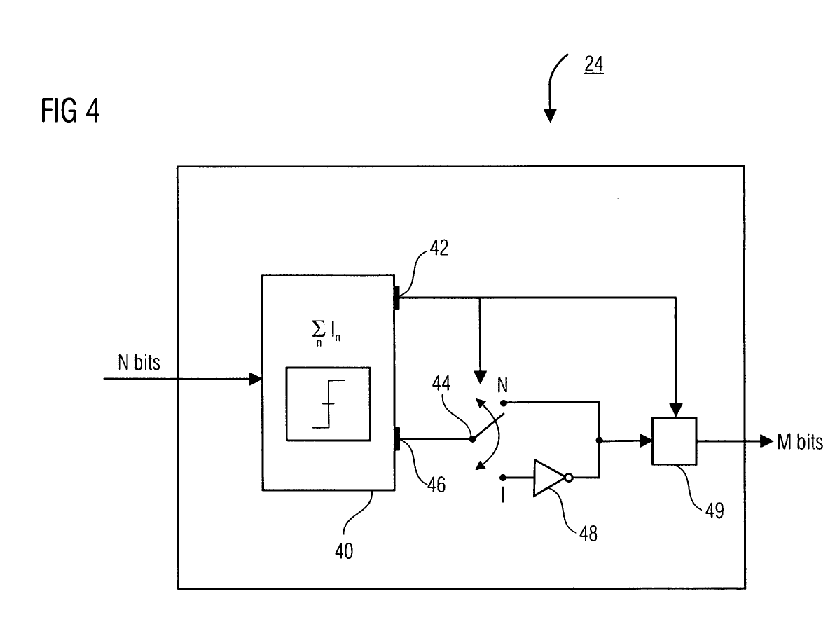

FIG. 4 shows a block diagram of an embodiment of the circuit 24 and/or means for mapping the N-bit data word to the physical M-bit memory data word.

The N-bit data word is supplied to an analysis unit 40 in which the individual information bits Iₙ are exemplarily summed up, as has already been described before. If the predetermined threshold value, like, for example, N/2, is exceeded, the inversion signal which may be applied to the output 42 of means 40 will take the value “1” and will put a switch 44 at an output 46 for the data word to the switch position “I”. Thus, the bit values of the N-bit data word are inverted by means of an inverter 48. According to embodiments, either at the beginning or at the end of the N-bit data word, the inversion signal will be added to the data word in the form of a control bit. This takes place in the circuit section 49. Subsequently, the M-bit memory data word, M=N+1, which from there may be written to memory cells, is available at the output of the circuit 24.

After having described in detail how a first N-bit data word may be mapped and/or transformed to a second M-bit data word in order to be able to store the N-bit data word in volatile memories including a higher data retention failure rate, it will be discussed subsequently how the original N-bit data word can be recovered again from the transformed stored M-bit memory data word.

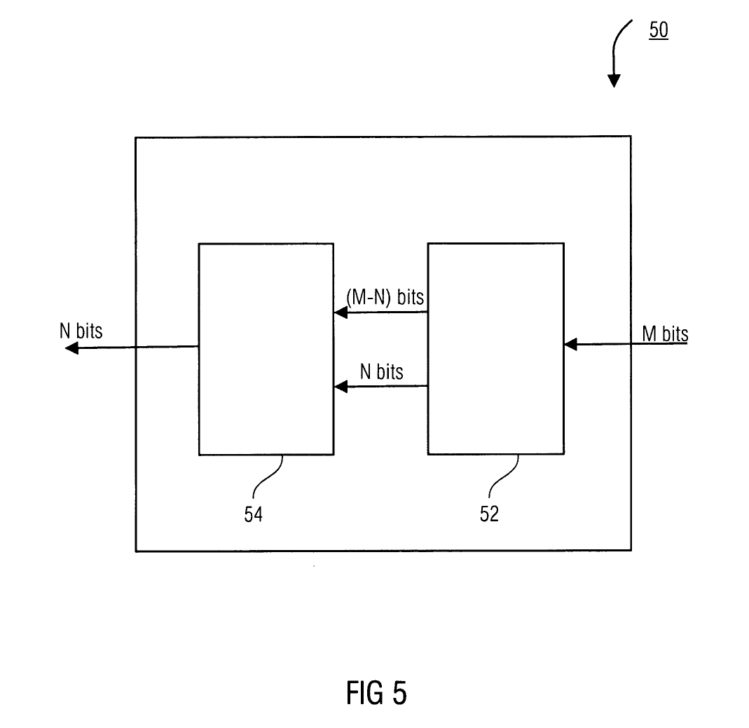

A device 50 for reading out an N-bit data word from a memory according to an embodiment of the present invention is shown in FIG. 5.

The device 50 comprises means 52 for reading a physical M-bit memory data word from memory cells. Additionally, the device 50 comprises means 54 for outputting an N-bit part of the M-bit memory data word or an inverted version of the N-bit part as the N-bit data word.

According to embodiments, the means 52 for reading is adapted to obtain the inversion signal from (M−N) bits of the M-bit memory data word, the inversion signal indicating whether an inverted or a non-inverted version of the N-bit part is to be output. According to embodiments, the means 52 passes the inversion signal established in this way, together with the N-bit part of the M-bit memory data word, on to the means 54 for outputting.

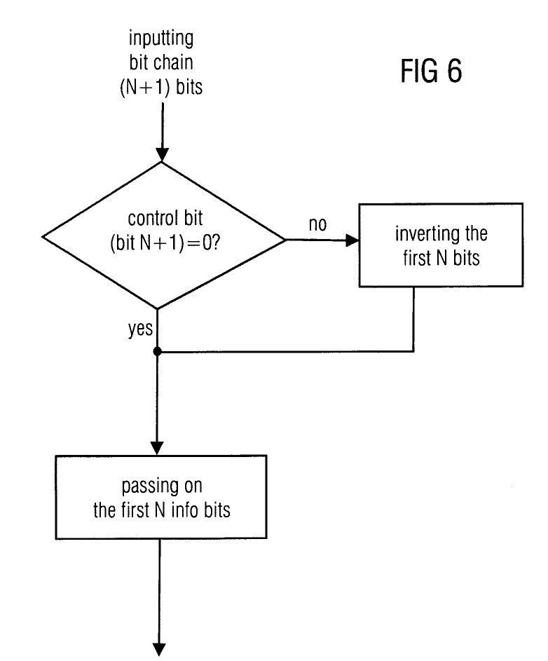

Individual steps which according to embodiments are executed by the device 50 for recovering the original N-bit data word from the M-bit memory data word are illustrated schematically in the flowchart of FIG. 6.

After reading the M-bit memory data word, a check is performed whether the inversion signal and/or control bit indicates that the N-bit data word is to be inverted. If the control bit is, for example, “1”, this will signify an inversion of the N-bit part of the M-bit memory data word to be performed in order to obtain the N-bit data word at the output of the device 50. If the inversion and/or control bit is “0”, no inversion of the N-bit part of the M-bit memory data word will be necessary in order to obtain the N-bit data word. A reverse configuration of the control bit is, of course, also conceivable, i.e., “0” signifying inversion, and “1” signifying no conversion.

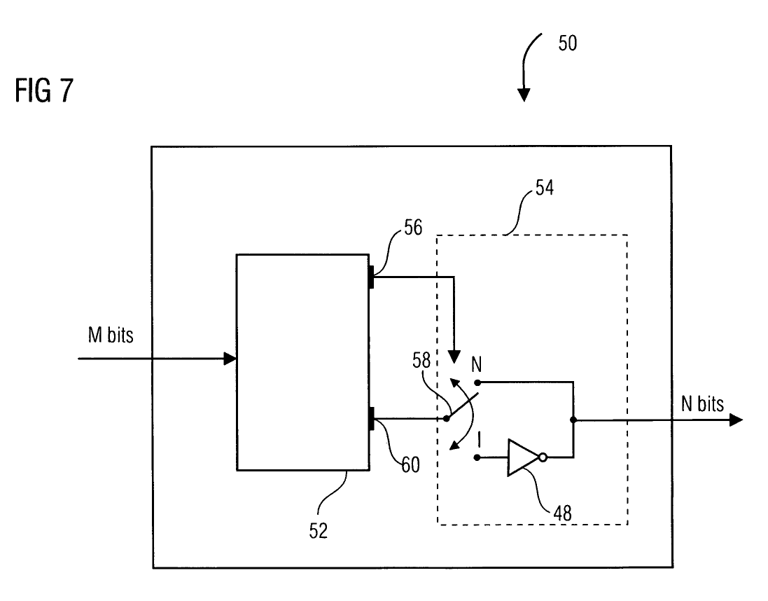

A block diagram of another embodiment of a device for reading out an N-bit data word is shown in FIG. 7.

In the means 52, the M-bit memory data word coming from memory cells is read and the inversion signal stored before is established. The inversion signal is available at the output 56 of the means 52 and controls the switch 58 at the output 60 of the means 52. Depending on the inversion signal (“1” or “0”), the switch 58 is put to the switch position “I” or “N”. In the switch position “N”, the N-bit part of the M-bit memory data word applied to the output 60 is passed on to the output of the device 50 as an N-bit data word in a non-inverted manner. If the switch 58 is in the switch position “I”, the N-bit part of the M-bit memory data word applied to the output 60 will be inverted by means of the inverter 48 in order to obtain the N-bit data word at the output of the device 50.

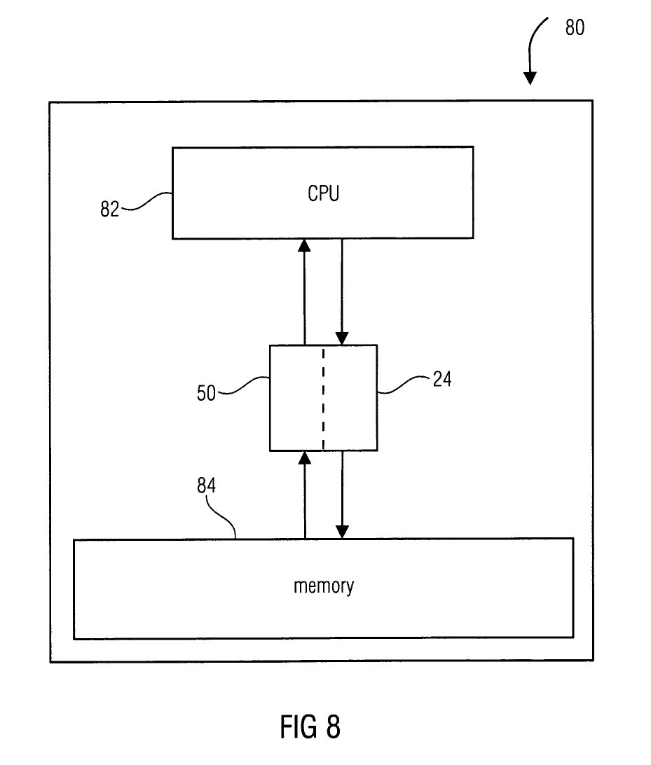

FIG. 8 as an overview shows a block diagram of a computer system or microcontroller 80 according to an embodiment of the present invention.

The computer system 80 comprises a processor and/or a CPU 82 which is coupled to a memory unit 84. Coupling according to embodiments may be via a memory controller and/or a memory bus. Devices 24 and/or 50 are introduced into the coupling path between the CPU 82 and the memory 84. N-bit data words are mapped to M-bit memory data words via the device 24 in the direction from the CPU 82 to the memory 84, as has already been described before. In the reverse direction, M-bit memory data words coming from the memory 84 are transformed to N-bit data words by the device 50 in order to reach the CPU 82 again.

It is to be emphasized here that the devices 24 and/or 50 may also be integrated into the CPU 82 or the memory 84. Furthermore, the devices 24 and/or 50 may be integrated into a memory controller circuit not illustrated here explicitly or into a memory buffer.

Embodiments of the present invention provide for a suitable transformation for bit chains and/or data words before storing same in capacitance-based memory cells. The same transformation is used when the bit chains and/or data words are read out from the memory cells. The mapping increases the number of physical zeros stored compared to the number of physical ones stored in the case of a better data retention of the memory for physical zeros. If the memory has a better data retention for physical ones, the number of physical ones stored compared to the number of physical zeros stored may be increased by embodiments of the present invention.

Using embodiments of the present invention, it is possible to reduce the data retention failure rate of capacitance-based memory elements and modules by a factor of two or more.

In summary, it is to be pointed out that the present invention is not limited to the respective elements of the device or the procedure discussed, since these elements and methods may vary. The purpose of the terms used here is only to describe special embodiments, and they are not used in a limiting sense. When the singular form or indefinite articles are used in the description and claims, this also refers to the plural of these elements, unless the context explicitly indicates something different. The same applies vice versa.

Depending on the circumstances, the inventive method may be implemented in either hardware or software. The implementation may be on a digital storage medium, in particular on a floppy disc or a CD having control signals which may be read out electronically which can cooperate with a programmable computer system such that the corresponding method will be executed. Generally, the invention is thus also in a computer program comprising a program code stored on a machine-readable carrier for performing the inventive method when the computer program product runs on a computer and/or microcontroller. In other words, the present invention is also a computer program comprising a program code for performing the method when the computer program runs on a computer and/or microcontroller.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents that fall within the true spirit and scope of the present invention.

What is claimed is:

1. A device comprising:
an input for an N-bit data word;
a circuit adapted to map the N-bit data word to a physical M-bit memory data word by means of a mapping rule, the mapping rule comprising a quantity of values of possible physical M-bit memory data words the mean number of first physical bit values of which is smaller than N/2, the circuit comprising an output for the physical M-bit memory data word; and
memory cells couplable to the output.

2. The device of claim 1, wherein the mapping rule comprises a quantity of values of possible physical M-bit memory data words the mean number of first physical bit values of which is smaller than or equal to (N/4+¾), N being greater than or equal to 4.

3. The device of claim 1, wherein the circuit is adapted to check whether a number of bits comprising a first logical bit value in the N-bit data word comprises a predetermined relation to a predetermined threshold value and to output, in this case, an inversion signal and, depending thereon, the N-bit data word at the output in an inverted or non-inverted manner.

4. The device of claim 1, wherein the circuit is adapted to check whether a number of bits comprising a logical zero in the N-bit data word is greater than N/2.

5. The device of claim 1, wherein the circuit is adapted to check whether a number of bits comprising a logical one in the N-bit data word is greater than N/2.

6. The device of claim 1, wherein the circuit is adapted to add an additional control bit corresponding to an inversion signal to the mapped N-bit data word in order to acquire the M-bit memory data word.

7. The device of claim 1, wherein the memory cells are capacitance-based memory cells.

8. The device of claim 7, wherein the capacitance-based memory cells are DRAM memory cells.

9. A device comprising:
capacitance-based memory cells;
an input for an N-bit data word;
a circuit adapted to check whether a number of bits comprising a first logical bit value in the N-bit data word comprises a predetermined relation to a predetermined threshold value and, in this case, to output an inversion signal; and
an inversion circuit couplable to the input to output, depending on the inversion signal, the N-bit data word to the memory cells in an inverted or non-inverted manner.

10. The device of claim 9, wherein the circuit is adapted to check whether a number of bits comprising a logical zero in the N-bit data word is greater than N/2.

11. The device of claim 9, wherein the circuit is adapted to check whether a number of bits comprising a logical one in the N-bit data word is greater than N/2.

12. The device of claim 9, wherein the circuit is adapted to add an additional control bit corresponding to the inversion signal to a mapped N-bit data word in order to acquire a M-bit memory data word.

13. The device of claim 9, wherein the capacitance-based memory cells are DRAM memory cells.

14. A device for storing an N-bit data word, comprising:
means for mapping the N-bit data word to a physical M-bit memory data word, M being greater than N, by means of a mapping rule, the mapping rule comprising a quantity of values of possible physical M-bit memory data words the mean number of first physical bit values of which is smaller than N/2; and
means for storing the physical M-bit memory data word.

15. The device of claim 14, wherein the means for mapping is adapted to check whether a number of bits comprising a first logical bit value in the N-bit data word comprises a predetermined relation to a predetermined threshold value and, in this case, to output an inversion signal and, depending thereon, the N-bit data word in an inverted or non-inverted manner.

16. The device of claim 14, wherein the means for mapping is adapted to check whether a number of bits comprising a logical zero in the N-bit data word is greater than N/2.

17. The device of claim 14, wherein the means for mapping is adapted to check whether a number of bits comprising a logical one in the N-bit data word is greater than N/2.

18. The device of claim 14, wherein the means for mapping is adapted to add an additional control bit corresponding to an inversion signal to the mapped N-bit data word in order to acquire the M-bit memory data word.

19. The device of claim 14, wherein the means for storing comprises capacitance-based memory cells.

20. The device of claim 19, wherein the capacitance-based memory cells are DRAM memory cells.

21. A method for storing an N-bit data word, comprising:
mapping an N-bit data word to a physical M-bit memory data word, M being greater than N, by means of a mapping rule, the mapping rule comprising a quantity of values of possible physical M-bit memory data words the mean number of first physical bit values of which is smaller than N/2; and
storing the physical M-bit memory data word.

22. The method of claim 21, wherein mapping includes performing a check as to whether a number of bits comprising a first logical bit value in the N-bit data word comprises a predetermined relation to a predetermined threshold value and, in this case, an inversion signal and, depending thereon, the N-bit data word in an inverted or non-inverted form are output.

23. The method of claim 21, wherein mapping includes performing a check as to whether a number of bits comprising a logical zero in the N-bit data word is greater than N/2.

24. The method of claim 21, wherein mapping includes performing a check as to whether a number of bits comprising a logical one in the N-bit data word is greater than N/2.

25. The method of claim 21, wherein mapping includes adding an additional control bit corresponding to an inversion signal to the mapped N-bit data word in order to acquire the M-bit memory data word.

26. The method of claim 21, wherein storing the physical M-bit memory data word comprises storing in capacitance-based memory cells.

27. A computer program for performing a method for storing an N-bit data word, when the computer program runs on a computer and/or microcontroller, the method comprising: mapping an N-bit data word to a physical M-bit memory data word, M being greater than N, by means of a mapping rule, the mapping rule comprising a quantity of values of possible physical M-bit memory data words the mean number of first physical bit values of which is smaller than N/2; and storing the physical M-bit memory data word.

28. A device for reading out an N-bit data word, comprising:
means for reading a physical M-bit memory data word from memory cells, M being greater than N; and
means for outputting an N-bit part of the M-bit memory data word or an inverted version of the N-bit part as the N-bit data word from the M-bit memory data word.

29. The device of claim 28, wherein the means for reading is adapted to determine an inversion signal of (M−N) bits of the M-bit memory data word, the inversion signal indicating whether an inverted or non-inverted version of the N-bit part is to be output.

30. The device of claim 28, wherein M=N+1.

31. A method for reading out an N-bit data word, the method comprising:
reading a physical M-bit memory data word from memory cells, M being greater than N; and
outputting an N-bit part of the M-bit memory data word or an inverted version of the N-bit part as the N-bit data word from the M-bit memory data word.

32. The method of claim 31, wherein when reading an inversion signal is determined of (M−N) bits of the M-bit memory data word, the inversion signal indicating whether an inverted or non-inverted version of the N-bit part is to be output.

33. The method of claim 31, wherein M=N+1.

34. A computer program for performing a method for reading out an N-bit data word, comprising: reading a physical M-bit memory data word from memory cells, M being greater than N; and outputting an N-bit part of the M-bit memory data word or an inverted version of the N-bit part as the N-bit data word from the M-bit memory data word, when the computer program runs on a computer and/or microcontroller.
